(19) United States
(12) Patent Application Publication
(10) Pub. No.: US 2010/0154087 A1
(43) Pub. Date: Jun. 17, 2010

(54) METHOD FOR GROWING A CARBON NANOTUBE ON A NANOMETRIC TIP

(75) Inventors: Anne-Marie Bonnot, Paris (FR); Frederic Gay, Quaix En Chartreuse (FR); Pierre Henri Perrier, Grenoble (FR)

Correspondence Address: YOUNG & THOMPSON, 209 Madison Street, Suite 500, Alexandria, VA, 22314, US

(73) Assignee: Centre National De La Rechereche Scientifique (C.N.R.S, Paris (FR)

(21) Appl. No.: 12/526,450

(22) PCT Filed: Feb. 1, 2008
(86) PCT No.: PCT/FR2008/050171

§ 371 Date: Feb. 26, 2010

(30) Foreign Application Priority Data
Feb. 9, 2007 (FR) 0700925

(51) Int. Cl. G01Q 70/14; G01Q 70/16; G01Q 60/38

(52) U.S. Cl. 850/40; 850/60; 850/59; 977/742; 977/932

(57) ABSTRACT

The invention relates to a method for the catalytic growth of carbon nanotubes on nanometric tips by chemical vapour deposition assisted by a hot filament, that comprises a first step of applying a preliminary dual-layer coating of cobalt and titanium on said tip, the titanium layer having a thickness of between 0.1 nm and 0.2 nm and cobalt layer having a thickness of between 0.3 nm and 2 nm.

The present invention concerns a method for growing carbon nanotubes on tips of nanometric dimension, and more specifically the location, orientation and anchorage with good mechanical behaviour of an isolated carbon nanotube, single-wall or multi-walled, with a number of walls of ≦4, or of a small bundle of 2 to 3 carbon nanotubes, on a tip of nanometric dimension, with an improved success rate.

After the discovery of carbon nanotubes, much research has been carried out in order to define their properties, especially in the field of nanosciences, and to explore the avenues which they might provide in the domain of nanotechnology.

Carbon nanotubes (CNTs) are cylindrical molecules the structure of which may be represented as a sheet of graphite rolled up on itself. In this case, the term single-wall carbon nanotube is used. When the structure of the carbon nanotube can be represented by a plurality of rolled up and concentric graphite sheets, the term multi-walled nanotubes is then used.

Owing to their geometric appearance, their great longitudinal rigidity, and their chemical inertness, carbon nanotubes are of quite particular interest in the domain of Near Field Microscopy (NFM). Under this heading, the interest of tips having a carbon nanotube has been demonstrated (see for example Dai et coll., Nature, 384, (1996), 147 onwards) and such tips carrying nanotubes could become an undeformable element as a probe for atomic force microscopy (AFM).

In fact, the existing products for use as a probe in atomic force microscopy are especially silicon tips, the lateral resolution of which is currently from 10 to 20 nm, i.e. of the order of magnitude of the size of the apex; the best have an ultimate resolution close to 5 nm, but are very fragile at the apex as soon as they are subjected to the least contact when approaching the surface to be studied. Moreover, obtaining high quality images of the steep flanks present on some electronic circuits, in order to establish the quality of said circuits, is relatively difficult, especially with tips of pyramidal shape; moreover, for certain applications, the silicon of the tip may pollute or react chemically with the surface analysed.

In order to remedy these drawbacks, it has already been proposed to graft carbon nanotubes at the apex of nanometric tips. To this end, much research has been carried out in order to propos, inter alia, methods of manufacture of probes for AFM onto which carbon nanotubes are fixed, especially at the apex of the tip of the cantilever of the probe.

Nowadays, two generic types of fixing of nanotubes on the probes are known, i.e. the “mechanical” methods and the “chemical” methods.

In the mechanical methods, the carbon nanotubes are fixed by adhesive means one by one onto the probes. It is easy to understand the difficulty of implementing such a method resulting in incompatibility with large scale production, especially for reasons of time and associated costs.

In addition, these adhesive securing methods generally concern multi-walled nanotubes (number of walls of the order of 10 or more), which certainly have the advantage of being very robust, but in which the diameter of at least 10 nm results in a poor resolution quality, especially a poor lateral resolution quality.

As for the chemical methods, these mainly make use of the chemical vapour deposition technique or CVD. It is possible to cite, for example, the works of Cheung C. L. et coll. (PNAS, 97, (2000), 3809 onwards), of Yenilmez E. et coll. (Appl. Phys. Lett., 80, (2002), 2025 onwards), of Snow, E. S. et coll. (Appl. Phys. Lett., 80, (2002), 2002 onwards), or those of Qi Ye et coll. (Nanolett., 4, (2004), 1301 onwards).

These methods generally lead to the grafting of not only a plurality of carbon nanotubes at the apex of the tips, but also to the appearance of a large quantity of nanotubes on the flanks of the tips. Still other methods are relatively difficult to carry out on an industrial scale, since they employ complex and/or onerous multiple steps.

As another example, Patent Application WO-A1-2004/094690 discloses a method for growing carbon nanotubes on a substrate pre-coated with a dual-layer of titanium and cobalt, the titanium layer being between 0.5 nm and 5 nm and the cobalt layer being between 0.25 nm and 10 nm. According to this method, the nanotubes grow from the lateral surface of the dual-layer, without being able to favour the growth of an isolated nanotube at the apex of a silicon tip.

As a consequence, it is sought to improve the methods for the grafting of carbon nanotubes, especially at the apex of tips, and which can be transposed to an industrial scale, with acceptable production costs and providing finished products possessing the qualities required for the applications envisaged.

Thus, a first aim of the present invention consists in proposing a method for growing a carbon nanotube, or a small bundle of carbon nanotubes, single-wall or having a number of walls of ≦4, at the apex of a tip of nanometric size, said method comprising simple steps, relatively easy to transpose to an industrial scale.

Another aim of the invention is to optimise the growth of the carbon nanotubes at the apex of tips, especially nanometric tips, for example probe tips usable in atomic force microscopy.

Another aim is to optimise and facilitate the growth of carbon nanotubes substantially isolated and only at the apex of tips, especially nanometric tips.

As another aim, the invention proposes the optimisation of the growth of isolated carbon nanotubes substantially only at the apex of tips, essentially in the direction of the axis of the tip.

Another aim is to provide a large scale method for manufacturing batches of tips, the ends (apices) of which include an isolated carbon nanotube, or a small isolated bundle of carbon nanotubes.

Another aim of the invention is a method for growing in batches isolated carbon nanotubes at the apex of nanometric tips, especially tips supported by cantilevers.

Another aim is the production, in batches, of probes for AFM of the cantilever type, wherein the apex of the tips is grafted by at least one carbon nanotube with one, two, three or even a maximum of four walls, preferably one to three walls.

Still other aims will be mentioned in the following description of the invention.

Thus, a first subject of the present invention is a method for the catalytic growth of an isolated carbon nanotube at the apex of a nanometric tip by chemical vapour deposition (CVD), for example chemical vapour deposition assisted by a hot filament (HFCVD), comprising a step consisting in pre-coating said tip, completely or partially, with a dual-layer of titanium and cobalt, the titanium layer having a thickness of between 0.1 nm and 0.2 nm, and the cobalt layer having a thickness of between 0.3 nm and 2 nm.

By “nanometric tip” there is to be understood any type of point of nanometric size, such as those used in the different domains employing nanometric techniques and devices, for example electronics, opto-electronics, near field microscopy, atomic force microscopy, and others. Nanometric tips are well known to a skilled person in the art and may be formed of any type of material, especially, semi-conductor materials.

As regards the present invention, nanometric tips are advantageously substantially formed of one or more semi-conductor materials selected from semi-conductors, III-V semi-conductors, semi-conductor nitrides, semi-conductor hydrocarbons, more particularly among the semi-conductors and semi-conductor nitrides, alone or in associations or combinations of two or more of these. Preferred examples of such materials are Si, SiC, Si₃N₄, AlN, Ga, Ge, GaN, InN, GaAs, GaAsAl, AlGaN, alone or in associations or combinations of two or more of these. Quite particularly preferred are the tips formed of silicon (Si) or silicon nitride (Si₃N₄) or an association or combination of these two materials in any proportions. In a particularly preferred manner, the tips are formed of silicon.

It should be understood in the present invention that the term “silicon” used as such or in the expressions “silicon tip”, “silicon chip”, and others, includes not only silicon as such, but also any other semi-conductor material as defined above, in particular silicon nitride, alone or in association/combination with silicon, which may be used in a manner equivalent to silicon in the domains envisaged. Thus, the present invention also includes the methods of improved growth of carbon nanotubes as defined above, on tips of silicon nitride, alone or in association/combination with silicon.

Thus, the inventors have surprisingly discovered that the deposition of the dual-layer as defined above permits the location and anchorage, with good mechanical behaviour, of an isolated carbon nanotube, or a small isolated bundle of 2 to 3 nanotubes, single-wall or with a number of walls of ≦4, generally 2 or 3 walls, at the apex of a nanometric tip.

According to one embodiment of the invention, the cobalt layer is preferably formed on the titanium layer. According to another embodiment, the titanium layer is formed on the cobalt layer.

The invention thus lies in the implementation of the CVD method, preferably HFCVD, associated with a titanium/cobalt dual-layer deposited previously on a nanometric tip which makes it possible to increase the probability of locating a carbon nanotube, or a small bundle of carbon nanotubes, compared with a similar method using a single layer of catalyst for growing nanotubes.

It should also be understood that the tip may be coated completely or partially by the dual-layer defined previously. When only a part of the tip is coated by the dual-layer, it is preferred that the coating is present at least in the vicinity of the end of the tip (apex), or even on the end of the tip. The techniques of partial coating of a layer of catalyst are known to a skilled and may be applied to the dual-layer of the method of the present invention.

According to another aspect, the present invention permits control of the length of the nanotubes, by varying the thickness of the layer of cobalt, without substantially altering the probability of location of a nanotube at the apex of a tip. Thus, according to the targeted application, the nanotubes grafted according to the method of the invention may, for example, have a length of between a few tenths of a nm and several μm, advantageously less than or equal to 1 μm.

More precisely, their length is between 20 nm and 3 to 4 μm, more preferably between 100 to 500 nm and 1 μm. For example, for applications in atomic force microscopy (AFM), the method of the present invention makes it possible to obtain grafted carbon nanotubes of a precisely controlled length of between 200 nm and 300 nm. For other applications, other precisely controlled lengths may be obtained.

The nanotubes also have the advantage of being grafted substantially at the apex of the tip and in an orientation, along the axis of the tip, equal to ±20°. These properties enable, especially, excellent qualities of imaging by atomic force microscopy.

These excellent imaging qualities result especially from the robustness of the assembly due to the method of the invention, from the absence of chemical reaction with the surface to be studied, owing to the inert constituent of the nanotube, which is carbon.

Moreover, by reason of the small number of nanotubes grafted (one nanotube or only a small bundle of nanotubes) and of their orientation (±20° with respect to the axis of the tip), it is possible to carry out imaging with excellent lateral resolution of steep flanks, imaging with excellent resolution of surfaces having roughness/unevenesses (hollows and protuberances), or breakages (current passages).

These resolutions may be less than, or equal to, 5 nm with reduced analysis times compared with conventional high resolution probes, for example analysis times reduced by a factor which may be up to around 10, without alteration to the resolution.

The method of the invention is a self-assembly technique which, by simple deposition of at least the dual-layer previously defined, makes it possible to optimise and locate the growth by (HF)CVD technique of a nanotube at the apex of a nanometric tip, preferably a tip of silicon and/or silicon nitride. This method is thus particularly suitable for the batch manufacture of grafted carbon nanotubes on nanometric tips distributed on a surface, without requiring any after-treatment.

The inventors have actually discovered that the method of the invention makes it possible to increase the probability of grafting of carbon nanotubes having a length of between 20 nm and 3 to 4 μm, compared with the known methods of the prior art.

It is known, for example, that for commercial tips, coated with a single layer of cobalt (catalyst for growing carbon nanotubes) before the step of growth of the carbon nanotubes, the success rate for growth of an isolated nanotube at the apex of the tip generally varies between 20% and 60%, according to the operating conditions, and the nature, quality, size and shape of the tips.

According to the method of the present invention, the tips pre-coated with the titanium/cobalt dual-layer previously defined are grafted by an isolated carbon nanotube (or a small isolated bundle of nanotubes, as previously defined) with an improved success rate, of from 40% to 80%, generally from 50% to 80%, for a minimum number of at least 100 tips, treated in batches of at least 30 tips. A success rate of 100% has even been observed on batches of 10 silicon tips.

The success rate is defined as the ratio between the number of tips grafted by an isolated nanotube or a small isolated bundle of nanotubes, as previously defined, and the total number of tips engaged in the method of the invention, expressed as a percentage.

In other words, the method of the present invention makes it possible, in a simple manner and without any step of after-treatment, to improve the yield of the known methods of the prior art by a factor of the order of 2, or even greater than 2, and therefore to reduce significantly the cost of manufacture of the grafted tips and consequently their selling price.

According to yet another aspect, the method of the invention, comprising the step of application of the dual-layer described previously, avoids the generation of a large number of nanotubes on the surface of the tip, while facilitating the growth of at least one isolated nanotube at the apex of the tip.

The method of the invention in fact makes use of a thickness of cobalt which is thinner than that currently used in the field. This lesser thickness of cobalt results in a great reduction in the density of tubes deposited on the substrate (tip, cantilever, probe, wafer and others) and thus allows said substrate to preserve its appearance, in particular its colour and brilliance, and therefore its reflective power in the visible spectrum. This makes it possible at least to preserve the initial properties of the substrate.

Without wishing to be constrained by any theory, it was observed that, all other things being equal, in the dual-layer of the method of the invention, the variation of the quantity of cobalt, known for catalysing the reaction of growth of carbon nanotubes, enables the length of the nanotubes to be varied, and that the variation in the quantity of titanium enables the density of carbon nanotubes to be varied.

In other words, it is considered that the present invention makes it possible to separate the probability of anchorage of a carbon nanotube (or of a small bundle of carbon nanotubes) fundamentally governed by the titanium, from the length of the nanotube(s), which depends fundamentally on the thickness of the layer of cobalt.

In addition, the carbon nanotubes, obtained at the apex of tips according to the method of the present invention, are substantially or even completely uniform within the same batch and between different batches.

Thus, the present inventors have succeeded in optimising the titanium/cobalt ratio, in order to optimise the compromise of low density of growth/small diameter/length of the nanotubes at the apex of nanometric tips, leading to an increased probability of location and strong anchorage of a carbon nanotube (or of a small bundle of carbon nanotubes) at the end (apex) of tips.

According to another advantage of the present invention, the diameter and the structure (single-wall, multi-wall) of the nanotubes are substantially uniform.

The diameter of the nanotubes grafted according to the method of the present invention is generally of the order of 1 to 8 nm, preferably of the order of 1 to 5 nm, typically of the order of 1 to 3 nm for single-wall nanotubes, and of the order of 2 nm to 5 nm for nanotubes having two concentric walls.

The first step of the method of the invention thus concerns the deposition of a dual-layer comprising titanium and cobalt, as previously defined, on any type of substrate, especially a semi-conductor substrate, for example of silicon and/or of silicon nitride, such as for example, a wafer (silicon chip), a probe or a cantilever, comprising at least one tip at the apex of which the growth of a nanotube (or of a small bundle of nanotubes) of carbon according to the method of the invention is desired.

The deposition of the thin layers may be carried out by any method known to a person skilled in the art and, for example, by evaporation, spraying or any other method for depositing thin layers which is customarily used with the substrates usable within the framework of the present invention.

For the requirements of the present invention, the thicknesses of titanium and cobalt are measured by means of a quartz, the natural frequency of which varies in a known manner when it is coated with a thin layer and therefore its mass increases. The quartz is positioned as close as possible to the deposition surface. This measurement of thickness is controlled once and for all by measurement of step height on a standard substrate on which the material has been deposited.

In a second step, the growth of the nanotubes is effected by the implementation of a catalytic chemical vapour deposition method, preferably assisted by a hot filament (HFCVD method), known to a person skilled in the art, and as described for example by L. Marty et coll. (Microelectronic Engineering, 61-62 (1), (2002), 4585-489).

This growth step is generally carried out in the presence of an atmosphere of gaseous hydrocarbon, such as methane, ethylene or acetylene, preferably methane, and optionally, but preferably, hydrogen and at a temperature of around 800° C.

It is in fact known that carbon nanotubes may form by reaction between a carbon-containing vapour and catalytic particles, typically cobalt, iron or nickel, which have the property of dissolving the carbon located on their surface.

In the technique of chemical vapour deposition assisted by a hot filament, the catalytic particles are formed in situ by de-wetting a thin layer of cobalt previously deposited on a substrate by the action of a violent increase in temperature. The vapour is decomposed by a filament heated to around 1900-2050° C. and placed opposite the surface of the substrate.

The carbon-containing vapour, source of carbon and atomic hydrogen, has the property of gasifying the disordered forms of carbon. The catalytic reaction of the cobalt particles with the carbon-containing vapour on a substrate coated with the dual-layer previously defined and brought to a temperature of the order of 700-900° C. makes it possible to obtain single-wall nanotubes or multi-walled nanotubes with a small number of walls (≦4) and having a good crystalline quality.

The method of the present invention is a method for the catalytic growth of an isolated carbon nanotube or a small isolated bundle of carbon nanotubes, at the apex of a nanometric tip, for example of silicon and/or of silicon nitride, by chemical vapour deposition (CVD), for example chemical vapour deposition assisted by a hot filament (HFCVD), comprising:
a) the deposition on the whole or part of said tip of a dual-layer of titanium and cobalt, the titanium layer having a thickness of between 0.1 nm and 0.2 nm and the cobalt layer having a thickness of between 0.3 nm and 2 nm;
b) the implementation of a catalytic method by chemical vapour deposition, preferably assisted by a hot filament (HFCVD method), for growing said nanotube or said small bundle of nanotubes; and
c) obtaining the tip, at the apex of which is grafted an isolated carbon nanotube or a small isolated bundle of carbon nanotubes, single-wall or multi-walled with a small number of walls (≦4).

As indicated previously, the substrate, completely or partially coated with the titanium/cobalt dual-layer according to the invention, comprises at least one tip. The tip may be of any suitable shape and size for the applications envisaged, and in particular of different geometric shapes, with square, rectangular, triangular, circular or other base, i.e. tips of conical or pyramidal shape, the tips optionally being truncated.

A substrate, such as a wafer, a probe, a cantilever, or a tip, coated with a titanium/cobalt dual-layer, the layer of titanium having a thickness of between 0.1 nm and 0.2 nm, and the cobalt layer having a thickness of between 0.3 nm and 2 nm, is new and is included in the scope of the present invention.

Said substrate comprises, or is substantially formed by, one or more semi-conductor materials, such as were previously defined, and preferably the substrate comprises or is formed of silicon, silicon nitride or an association/combination of silicon/silicon nitride.

It should be understood that said substrate has at least one tip, and that said substrate may be coated completely or partly with said dual-layer, provided that said tip is coated with said dual-layer, at least on its tapered part, at the apex, or at least in the vicinity of the apex of said tip.

According to another aspect, the present invention relates to the method of growing carbon nanotubes at the apex of tips, said method being carried out in batches. The term “in batches” means that it is possible to treat simultaneously a large number of tips, generally disposed on a substrate.

The invention therefore solves the problem of anchorage of an isolated carbon nanotube (or of a small isolated bundle of carbon nanotubes) at the apex of a tip, for any nano device, i.e. any substrate having at least one tip, with a technique of self-assembly in batches, in other words of simultaneously growing at the apex of the tips of a plurality of nano devices an isolated carbon nanotube or a small isolated bundle of carbon nanotubes.

The nano devices may therefore be treated simultaneously, in batches, said nano devices being generally distributed on surfaces of all sizes, for example surfaces 2 inches (5.08 cm) in diameter, 4 inches (10.16 cm) in diameter, and even surfaces 6 inches (15.24 cm) in diameter. Commercial substrates (for example silicon chips) having the above dimensions may for example include respectively up to 120 devices, up to 480 devices, and even up to 1080 devices, which may all be treated simultaneously according to the method of the invention, i.e. coating of the dual-layer and growth of the nanotubes.

By means of the method of the invention, the success rate, i.e. the percentage of tips at the apex of which an isolated carbon nanotube, or a small isolated bundle of carbon nanotubes, is grafted as previously described, may be from 40% to 80%, and even 100%.

This success rate (presence or otherwise of a nanotube or a small bundle of nanotubes at the apex of a tip) is evaluated by observation of the tips by means of a scanning electron microscope, of the field emission type.

Thus, the aim of the present invention is a method for the optimised growth of carbon nanotubes at the apex of tips. The applications of these tips grafted according to the method of the present invention by at least one carbon nanotube or a bundle of 2 to 3 carbon nanotubes are numerous, as is known in the art and as a person skilled in the art may imagine, according to technological developments.

By way of non-limiting example, the tips grafted by an isolated carbon nanotube, or an isolated bundle of 2 to 3 carbon nanotubes, obtained according to the method of the invention may advantageously be used in the domain of near field microscopy and atomic force microscopy technology.

Other applications or developments in which the tips grafted according to the method of the invention may be deployed are those having recourse to devices requiring the location, anchorage and orientation of a carbon nanotube at one point with a free end, or at two points, without a free end, in silicon or silicon nitride nano devices such as NEMS (“Nano Electro Mechanical Systems”), transistors, sensors, and others, or the manufacture of NEMS, electrical circuits or sensors based on carbon nanotubes.

Thus, by way of non-limiting example, when the carbon nanotube is anchored to the apex of a tip, and the other end of the nanotube is free, said tip may be used in a high performance probe for Atomic Force Microscopy, in particular for the imaging of proteins or other biological materials.

When the nanotube is suspended between two points, one of which is the apex of a tip, the other being a surface, another tip, an electrode, or other, said nanotube may then be an element of any type of nano device, such as transistors, NEMS, or others.

The method of the present invention makes it possible in fact to obtain an improved success rate not only for the grafting of an isolated nanotube or of a small isolated bundle of nanotubes at the end of a tip, but also an improved success rate for the grafting of an isolated nanotube or of a small isolated bundle of nanotubes at the end of a tip, together with the growth and anchorage of said isolated nanotube or small isolated bundle of nanotubes on another tip, a surface, an electrode or other of a nano device, such as a transistor, NEMS or other.

The following examples are provided solely for the purpose of illustrating the present invention and have no limiting effect on the scope of protection conferred by the claims appended to the present description.

### EXAMPLES

Various methods for the growth of nanotubes are carried out under the following operating conditions:
Temperature of the filament: 1850° C. to 2100° C.;
Temperature of the substrate: 700° C. to 900° C.;
Quantity of hydrocarbon (methane): 5% to 20% by volume in hydrogen;
Total pressure: 2 mbar to 200 mbar.

Under the operating conditions described above, and with silicon tips (total number: 529) of pyramidal shape coated with a single layer of cobalt having a thickness of from 3.5 nm to 7 nm, the grafting rate of an isolated nanotube (or of a small isolated bundle of nanotubes) at the apex of the tips is approximately 18%.

Under the same conditions, the pyramid-shaped tips (total number: 600) being this time coated with a 0.1-0.2 nm layer of titanium, then with a 0.3 nm to 2 nm layer of cobalt, the grafting rate of an isolated nanotube (or of a small isolated bundle of nanotubes) at the apex of the tips is approximately 50%, i.e. an increase of around 245%.

Under the same operating conditions, and on silicon tips of conical shape, the grafting rate passes from 60% with a single layer of cobalt of optimised thickness of 4 nm, to reach 80% with a 0.1 nm layer of titanium coated with a layer of cobalt 1 nm thick.

The method of the present invention thus makes it possible not only to increase significantly the probability of grafting of an isolated nanotube (or of a small isolated bundle of nanotubes) at the apex of the tips, but also to reduce greatly the quantity of cobalt required for the growth of the nanotubes, with the advantage of preserving for the cantilever at least its initial reflection power.

On the other hand, during a method for growing nanotubes on a tip coated with a single layer of cobalt having a thickness of 7 nm, a blackish deposit is observed, formed by a strong density of graphitised cobalt particles and of nanotubes.

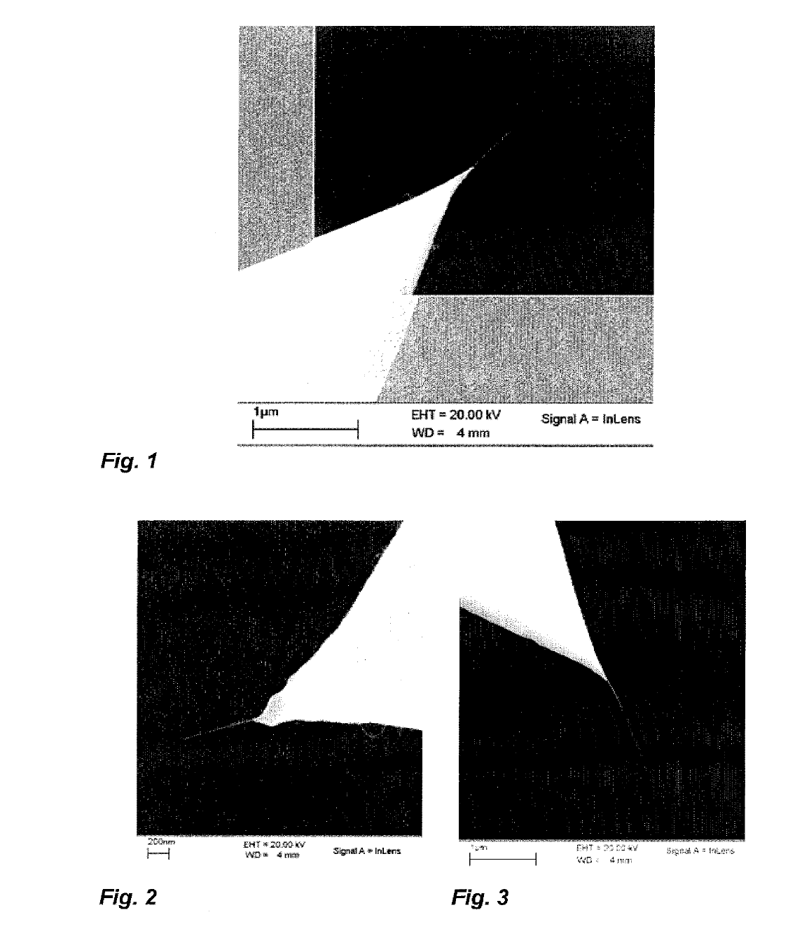

The drawings appended to the present description have the purpose of illustrating some embodiments of the invention, without implying any limitation thereto.
FIG. 1 shows a pyramid-shaped tip, the end of which is grafted, according to the method of the present invention, by an isolated carbon nanotube having a length of around 430 nm.
FIGS. 2 and 3 respectively show a tip grafted by an isolated carbon nanotube on a tapered tip of conical shape and on a tapered tip of pyramidal shape.

1-19. (canceled)

20. A method for the catalytic growth of an isolated carbon nanotube or a small bundle of nanotubes at the apex of a nanometric tip by chemical vapour deposition (CVD), optionally assisted by a hot filament (HFCVD), comprising a step consisting in pre-coating, completely or partly, said tip with a dual-layer of titanium and cobalt, the titanium layer having a thickness of between 0.1 nm and 0.2 nm and the cobalt layer having a thickness of between 0.3 nm and 2 nm.

21. The method of claim 20, wherein the tip is a tip made of silicon, or silicon nitride, or of silicon and silicon nitride.

22. The method of claim 21, wherein the tip is a tip made of silicon.

23. The method of claim 20, wherein the grafted nanotube is an isolated carbon monotube at the <?> of the nanometric tip.

24. The method of claim 20, wherein the cobalt layer is formed on the titanium layer.

25. The method of claim 20, wherein the titanium layer is formed on the cobalt layer.

26. The method of claim 20, wherein the deposition of the dual-layer is carried out according to an evaporation method.

27. The method of claim 20, wherein the chemical vapour deposition, optionally assisted by a hot filament, is carried out in the presence of an atmosphere of methane, ethylene, acetylene or another gaseous hydrocarbon, optionally, together with hydrogen, at a temperature of between 700 and 900° C.

28. The method of claim 27, wherein the chemical vapour deposition, optionally assisted by a hot filament, is carried out in the presence of an atmosphere of methane and hydrogen.

29. The method of claim 20, which is carried out on a batch of tips.

30. A substrate including at least one tip, coated completely or partially with a titanium/cobalt dual-layer, the titanium layer having a thickness of between 0.1 nm and 0.2 nm and the cobalt layer having a thickness of between 0.3 nm and 2 nm.

31. The substrate of claim 30, which comprises or is formed of silicon, of silicon nitride or of an association or combination of silicon and silicon nitride.

32. The substrate of claim 30, which is a nano device, a probe or a cantilever.

33. A substrate comprising one or more devices, tips or cantilevers, coated completely or partially, with a titanium/cobalt dual-layer, the titanium layer having a thickness of between 0.1 nm and 0.2 nm and the cobalt layer having a thickness of between 0.3 nm and 2 nm.

34. The substrate of claim 33, which comprises or is formed of silicon, of silicon nitride or of an association or combination of silicon and silicon nitride.

35. A nanometric tip obtained according to the process of claim 20, at the apex of which is grafted an isolated carbon nanotube, or a small isolated bundle of 2 to 3 nanotubes, single-wall or with a number of walls less than 4, the tip being coated completely or partially with a titanium/cobalt dual-layer, the titanium layer having a thickness of between 0.1 nm and 0.2 nm and the cobalt layer having a thickness of between 0.3 nm and 2 nm.

36. The tip of claim 35, which comprises or is formed of silicon, of silicon nitride or of an association or combination of silicon and silicon nitride.

37. The tip of claim 35, wherein the nanotube(s) have/has a length of between 20 nm and 3 to 4 μm.

38. The tip of claim 37, wherein the nanotube has a length of between 100 to 500 nm.

39. The tip of claim 35, wherein the nanotube(s) is/are grafted substantially at the apex of the tip and in an orientation, along the axis of the tip, of ±20°.

40. A probe for near field microscopy or atomic force microscopy, including the nanometric tip of claim 35.
